(19) United States
(12) Patent Application Publication
(10) Pub. No.: US 2017/0302483 A1
(43) Pub. Date: Oct. 19, 2017

(54) Receiver Based Envelope Detector

(71) Applicant: MAXLINEAR ASIA SINGAPORE PRIVATE LIMITED, Singapore (SG)

(72) Inventors: Roman RAINOV, Petah Tikva (IL); Moche Cohen, Pardes Hanna (IL)

(73) Assignee: MAXLINEAR ASIA SINGAPORE PRIVATE LIMITED, Singapore (SG)

(21) Appl. No.: 14/876,610

(22) Filed: Oct. 6, 2015

(51) Int. Cl. H04L 25/08; H04L 7/00; H04B 1/40; H04B 17/14

(52) U.S. Cl. CPC H04L 25/08; H04L 7/0091; H04B 17/14; H04B 1/40; H04L 7/0029

(57) ABSTRACT

A transceiver is disclosed which includes a transmitter and a receiver. The transmitter provides an impairment measurement signal, which is substantially similar to a transmitted communication signal except for a possible difference in phase and/or a magnitude, to the receiver. An envelope detector within the receiver provides an envelope of the impairment measurement signal to the transmitter. The transmitter determines sets of one or more filtering coefficients using the envelope of the impairment measurement signal and adjusts phases or magnitudes and/or phases of a sequences of bits used to generate the transmitted communication signal in accordance with the sets of one or more filtering coefficients to compensate for the unwanted distortion and/or the unwanted interference present within the transmitted communication signal.

### BACKGROUND

### Field of Disclosure

The present disclosure generally relates to a transceiver having a transmitter and a receiver and including compensating for impairments present within a transmitted communication signal provided by the transmitter using an envelope detector within the receiver.

### Related Art

The continued improvement of semiconductor fabrication processes has allowed manufacturers and designers to create a smaller and a more powerful electronic device. Electronic components within this smaller and more powerful device continue to be situated in closer proximity to each other. This close proximity of the electronic components makes signals flowing through these components more susceptible to unwanted distortion and/or unwanted interference.

One such electronic component commonly used in this smaller and more powerful device is a conventional transceiver. The conventional transceiver represents a communication device that includes both a transmitter and a receiver. The transmitter conventionally includes an envelope detector that is used by the conventional transceiver to compensate for the unwanted distortion and/or the unwanted interference. However, as the conventional transceiver continues to become smaller new unwanted distortions and/or new unwanted interferences appear. These new unwanted distortions and/or new unwanted interferences are unable to be compensated for using the envelope detector in the transmitter of the conventional transceiver.

### BRIEF DESCRIPTION OF THE DRAWINGS/FIGURES

FIG. 1 illustrates an exemplary transceiver according to an exemplary embodiment of the present disclosure;

FIG. 2 illustrates exemplary digital compensation circuitry that can be implemented within a transmitter of the transceiver according to an exemplary embodiment of the present disclosure;

FIG. 3 illustrates exemplary analog transmission circuitry that can be implemented within the transmitter of the transceiver according to an exemplary embodiment of the present disclosure; and

FIG. 4 illustrates exemplary analog, receiving circuitry that can be implemented within a receiver of the transceiver according to an exemplary embodiment of the present disclosure.

Embodiments of the disclosure are described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION OF THE DISCLOSURE

### Overview

A transceiver is disclosed which includes a transmitter and a receiver.

The transmitter provides an impairment measurement signal to the receiver, wherein the impairment measurement signal is substantially similar to a transmitted communication signal except for a possible difference in phase and/or a magnitude. An envelope detector within the receiver provides an envelope of the impairment measurement signal to the transmitter. The transmitter determines one or more filtering coefficients using the envelope of the impairment measurement signal and adjusts phases or magnitudes and/or phases of a sequences of bits used to generate the transmitted communication signal in accordance with the sets of one or more filtering coefficients to compensate for the unwanted distortion and/or the unwanted interference present within the transmitted communication signal.

A transmitter of a conventional transceiver includes a conventional envelope detector. The present disclosure essentially transfers the envelope detector from the transmitter to the receiver. This transferring of the envelope detector allows the transceiver of the present disclosure to compensate for more unwanted distortion and/or the unwanted interference present within the transmitted communication signal than is possible using the conventional transceiver. For example, the transceiver of the present disclosure can compensate for parasitic leakage of signals, such as local oscillator signals, into signal pathways of the envelope detector, parasitic coupling of signals, such as the sequences of bits, into the signal pathways of the envelope detector, and/or parasitic leakage of signals, such as the local oscillator signals, into the transmitted communication signal. Conventionally, the envelope detector of the conventional transmitter is positioned before amplification of the transmitted communication signal. As a result, the conventional transceiver cannot compensate for the unwanted distortion and/or the unwanted interference present within the transmitted communication signal that occur after the envelope detector within the amplification pathway of the conventional transmitter. The transferring of the envelope detector in the present disclosure to the receiver also allows the transceiver of the present disclosure to compensate for the unwanted distortion and/or the unwanted interference present within the transmitted communication signal in the amplification pathway of the transmitter that are present in the transmitted communication signal.

### An Exemplary Transceiver

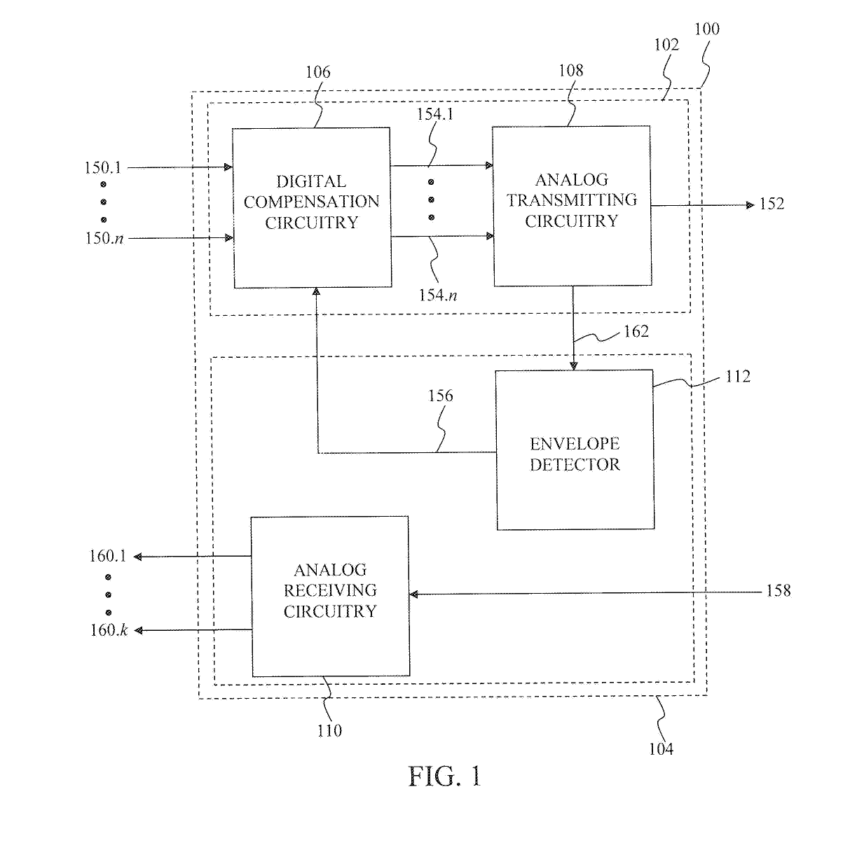

FIG. 1 illustrates an exemplary transceiver according to an exemplary embodiment of the present disclosure. A transceiver 100 is an electronic device having both transmitting and receiving capabilities. The transceiver 100 can operate in a full-duplex mode of operation allowing for simultaneous transmission and reception of electromagnetic signals or in a half-duplex mode of operation allowing for separate transmission and reception of electromagnetic signals. The transceiver 100 includes a transmitter 102 and a receiver 104. In an exemplary embodiment, the transmitter 102 and the receiver 104 can be formed onto a substrate, chip, or die. Alternatively, in another exemplary embodiment, the transmitter 102 and the receiver 104 can be formed onto multiple communicatively coupled substrates, chips, or dies within a mechanical enclosure.

The transmitter 102 operates on sequences of bits 150.1 through 150.n to provide a transmitted communication signal 152. The transmitter 102 includes multiple signal pathways to operate on the sequences of bits 150.1 through 150.n to generate the transmitted communication signal 152. Ideally, the multiple signal pathways are aligned in gain and/or amplitude. However, in practice, one or more of the multiple signal pathways are not aligned in gain and/or amplitude causing one or more mismatches between the multiple signal pathways. These mismatches can introduce unwanted distortion into the sequences of bits 150.1 through 150.n as the sequences of bits 150.1 through 150.n are being operated on by the transmitter 102. In some situations, the unwanted distortion can be sufficiently severe to prohibit the sequences of bits 150.1 through 150.n from being recovered from the transmitted communication signal 152. Furthermore, coupling of signals between the multiple signal pathways as well as coupling of other signals within the transmitter 102 on the multiple signal pathways can introduce unwanted interference onto the sequences of bits 150.1 through 150.n as the sequences of bits 150.1 through 150.n are being operated on by the transmitter 102. The coupling can include, for example, coupling of images of signals within the transmitter 102, for example, the transmitted communication signal 152, onto the multiple signal pathways or leakage of signals, such as local oscillator signals, within the transmitter 102 onto the multiple signal pathways. In some situations, the unwanted interference can be sufficiently severe to prohibit the sequences of bits 150.1 through 150.n from being recovered from the transmitted communication signal 152.

As illustrated in FIG. 1, the transmitter 102 includes digital compensation circuitry 106 and analog transmission circuitry 108. The digital compensation circuitry 106 includes multiple first signal pathways from among the multiple signal pathways of the transceiver 100 for operating on the sequences of bits 150.1 through 150.n to provide compensated sequences of bits 154.1 through 154.n. The multiple first signal pathways include multiple adaptive digital filters to adjust magnitudes and/or phases of the sequences of bits 150.1 through 150.n to compensate for the unwanted distortion and/or the unwanted interference present within the transmitted communication signal 152. The multiple adaptive digital filters adjust their own impulse responses in accordance with sets of one or more filtering coefficients using an adaptive filtering algorithm such as the Least Mean Squared (LMS), the Recursive Least Squares (RLS), the Minimum Mean Squared Error (MMSE) algorithms, or any other equivalent algorithm that will be apparent to those skilled in the relevant art(s) without departing from the spirit and scope of the present disclosure. The digital compensation circuitry 106 compares an envelope 156 of the transmitted communication signal 152 with each of the sequences of bits 150.1 through 150.n to generate multiple error signals. The digital compensation circuitry 106 adaptively generates the sets of one or more filtering coefficients which minimize the multiple error signals in accordance with the adaptive filtering algorithm.

The analog transmission circuitry 108 includes multiple second signal pathways from among the multiple signal pathways of the transceiver 100 for operating on the compensated sequences of bits 154.1 through 154.n to provide the transmitted communication signal 152. The multiple second signal pathways frequency convert the compensated sequences of bits 154.1 through 154.n in accordance with n phases of one or more local oscillator signals. In an exemplary embodiment, the compensated sequences of bits 154.1 through 154.n includes a first compensated sequence of bits 154.1 and a second compensated sequence of bits 154.2. In this exemplary embodiment, the multiple second signal pathways frequency convert the first compensated sequence of bits 154.1 and the second compensated sequence of bits 154.2 in accordance with two phases of a local oscillator signal, the two phases of the local oscillator signal being offset approximately ninety degrees from each other. The multiple second signal pathways combine the frequency converted compensated sequences of hits 154,1 through 154.n to provide the transmitted communication signal 152. Optionally, the multiple second signal pathways can amplify, attenuate, and/or filter one or more signals passing through the analog transmitting circuitry 108.

As additionally illustrated in FIG. 1, the receiver 104 includes analog receiving circuitry 110 and an envelope detector 112. The analog receiving circuitry 110 operates on a received communication signal 158 to provide recovered sequences of bits 160.1 through 160.k. The analog receiving circuitry 110 separates the received communication signal 158 to provide multiple received sequences of bits. The analog transmitting circuitry 108 frequency converts the multiple received sequences of bits in accordance with n phases of one or more local oscillator signals to provide the recovered sequences of bits 160.1 through 160.k. In an exemplary embodiment, the multiple received sequences of bits include two sequences of bits. In this exemplary embodiment, the analog receiving circuitry 110 frequency converts a first sequence of bits from among the two sequences of bits and a second sequence of bits from among the two sequences of bits in accordance with two phases of a local oscillator signal, the two phases of the local oscillator signal being offset approximately ninety degrees from each other. Optionally, one or more signals passing through the analog receiving circuitry 110 can be amplified, attenuated, and/or filtered.

The envelope detector 112 measures the envelope 156 of the transmitted communication signal 152 from an impairment measurement signal 162. The envelope detector 112 can be implemented using an analog envelope detector, such as a diode detector or a logarithmic detector to provide some examples, a digital envelope detector, or a mixed signal envelope detector. In an exemplary embodiment, the analog transmitting circuitry 108 can include an analog signal divider, such as a power divider or a directional coupler to provide some examples, to separate the combined, frequency translated sequences of bits 154.1 through 154.n into the transmitted communication signal 152 and the impairment measurement signal 162. In this exemplary embodiment, the impairment measurement signal 162 is substantially similar to the transmitted communication signal 152 except for a possible difference in phase and/or a magnitude. As such, the unwanted distortion and/or the unwanted interference are present within the transmitted communication signal 152 are similarly present within the impairment measurement signal 162. This allows the transceiver 100 to compensate for the unwanted distortion and/or the unwanted interference present within the transmitted communication signal 152 that are caused by the multiple first signal pathways of the transmitter 102 in their entirety.

### Exemplary Digital Compensation Circuitry that can be Implemented within a Transmitter of the Transceiver

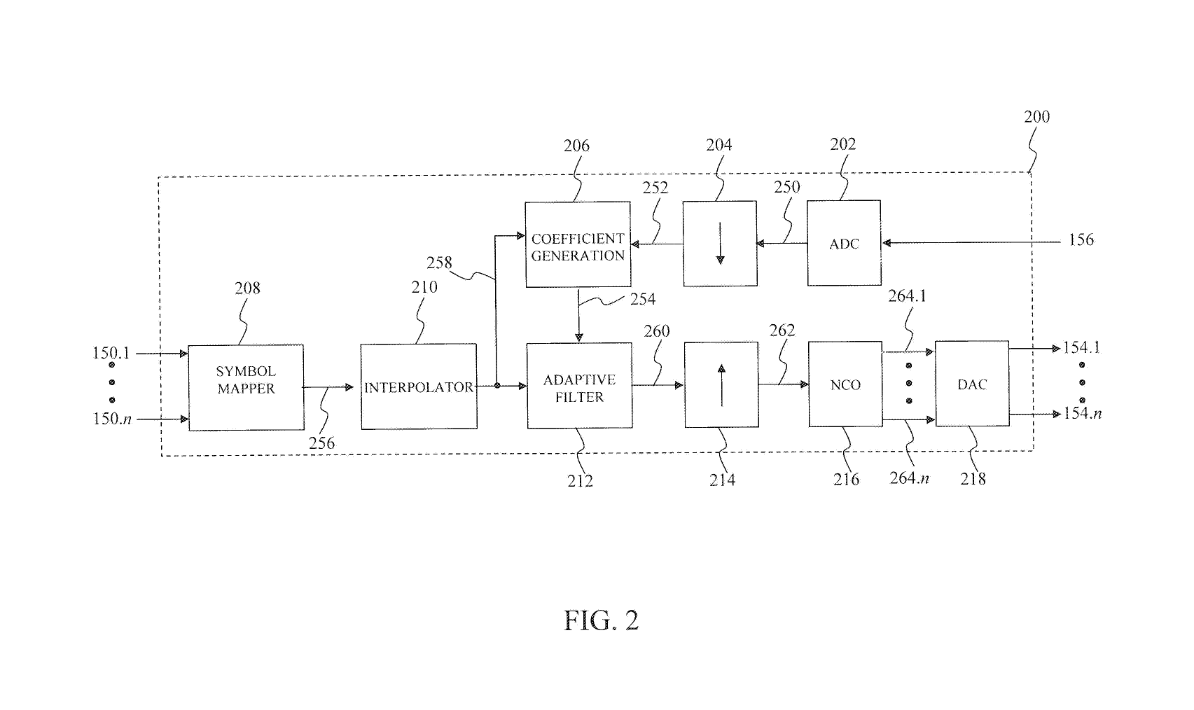

FIG. 2 illustrates exemplary digital compensation circuitry that can be implemented within a transmitter of the transceiver according to an exemplary embodiment of the present disclosure. Digital compensation circuitry 200 compensates for the unwanted distortion and/or the unwanted interference present within a transmitted communication signal, such as the transmitted communication signal 152 to provide an example, provided by a transmitter of a transceiver, such as the transmitter 102 of the transceiver 100 to provide an example, in the digital domain. The digital compensation circuitry 200 includes an analog-to-digital converter (ADC) 202, a digital downsampling module 204, a digital coefficient generation module 206, a symbol mapper module 208, a digital interpolator module 210, an adaptive filter module 212, a digital upsampling, module 214, a numerically controlled oscillator (NCO) 216, and a digital-to-analog converter (DAC) 218. The digital compensation circuitry 200 can represent an exemplary embodiment of the digital compensation circuitry 106.

The ADC 202 converts the envelope 156 of the transmitted communication signal from a representation in an analog signal domain to a representation in a digital signal domain to provide a sampled envelope 250. The ADC 202 samples the envelope 156 at a first data rate, such as approximately 1.2 Gigahertz (GHz), to provide the sampled envelope 250 at the first rate.

The digital downsampling module 204 decreases a data rate of the sampled envelope 250 from the first data rate to a second data rate and/or a sample size of the sampled envelope 250 to provide a downsampled envelope 252. In an exemplary embodiment, the digital downsampling module 204 decreases the data rate of the sampled envelope 250 by a factor of 6. In this exemplary embodiment, the first data rate of approximately 1.2 GHz for the sampled envelope 250 is decreased to the second data rate of approximately 200 Megahertz (MHz) for the downsampled envelope 252.

The digital coefficient generation module 206 compares the downsampled envelope 252 with an interpolated sequence of bits 258 at the second rate to generate an error signal. Thereafter, the digital coefficient generation module 206 generates one or more sets of one or more filtering coefficients 254 using an adaptive filtering algorithm which minimize the error signal. The adaptive filtering algorithm can include the Least Mean Squared (LMS). the Recursive Least Squares (RLS), the Minimum Mean Squared Error (MMSE) algorithms, or any other equivalent algorithm that will be apparent to those skilled in the relevant art(s) without departing from the spirit and scope of the present disclosure.

The symbol mapper module 208 maps the sequences of bits 150.1 through 150.n onto a symbol constellation in accordance with a digital modulation scheme to provide the digitally modulated sequence of bits 256. The digital modulation scheme can include phase shift keying (PSK), frequency shift keying (FSK), amplitude shift keying (ASK), quadrature amplitude modulation (QAM) and/or any other suitable modulation technique that will be apparent to those skilled in the relevant art(s).

The digital interpolator module 210 increases a data rate of a digitally modulated sequence of bits 256 from a third data rate to the second data rate to provide the interpolated sequence of bits 258. In an exemplary embodiment, the digital interpolator module 210 interpolates between samples of the digitally modulated sequence of bits 256 to increase the third data rate representing a baud rate of the digitally modulated sequence of bits 256 to the second data rate of approximately 200 Megahertz (MHz).

The adaptive filter module 212 includes an adaptive digital filter to adjust a magnitude and/or a phase of the interpolated sequence of bits 258 to compensate for the unwanted distortion and/or the unwanted interference present within the transmitted communication signal to provide a compensated sequence of bits 260. The adaptive digital filter adjusts its own impulse response in accordance with the one or more sets of one or more filtering coefficients 254 using the adaptive filtering algorithm.

The digital upsampling module 214 increases a data rate of the compensated sequence of bits 260 from the second data rate to a fourth data rate and/or a sample size of the compensated sequence of bits 260 to provide an upsampled sequence of bits 262. In an exemplary embodiment, the digital upsampling module 214 increases the data rate of the compensated sequence of bits 260 by a factor of 8. In this exemplary embodiment, the first second rate of approximately 200 MHz for the compensated sequence of bits 260 is increased to the fourth data rate of approximately 1.6 GHz for the upsampled sequence of bits 262.

The NCO 216 includes one or more digitally programmable oscillators that provide synchronous, discrete-time, discrete-valued representations of waveforms as sequences of bits 264.1 through 264.n. The one or more digitally programmable oscillators accumulate samples of the upsampled sequence of bits 262 to one or more phase accumulator output words at each sample of the upsampled sequence of bits 262. The one or more digitally programmable oscillators use the one or more phase accumulator output words as indexes to access various waveform look-up tables (LUTs) to provide the sequences of bits 264.1 through 264.n. In an exemplary embodiment, the sequences of bits 264.1 through 264.n are offset in phase from each other, for example, by approximately 90 degrees.

The DAC 218 converts the sequences of bits 264.1 through 264.n from a representation in the digital signal domain to a representation in the analog signal domain to provide the compensated sequences of bits 154.1 through 154.n. The DAC 218 samples the sequences of bits 264.1 through 264.n at the fourth data rate, such as approximately 1.6 Gigahertz (GHz) to provide an example, to provide the compensated sequences of bits 154.1 through 154.n at the fourth rate.

Although not illustrated in FIG. 2, those skilled in the relevant art(s) will recognize that the digital compensation circuitry 200 can include, one or more digital filters and/or one or more analog filters, such as one or more digital matched filters, one or more digital raised cosine filters, and/or analog low pass filters to provide some examples, without departing from the spirit and scope of the present disclosure. The one or more digital filters pulse shape various digital signals, such as the sequences of bits 150.1 through 150.n, the sampled envelope 250, and/or the compensated sequence of bits 260, within the digital compensation circuitry 200. The one or more analog filters decrease unwanted frequency components within various analog signals, such as the envelope 156 of the transmitted communication signal to provide an example, within the digital compensation circuitry 200.

### Exemplary Analog Transmission Circuitry that can be Implemented within the Transmitter of the Transceiver

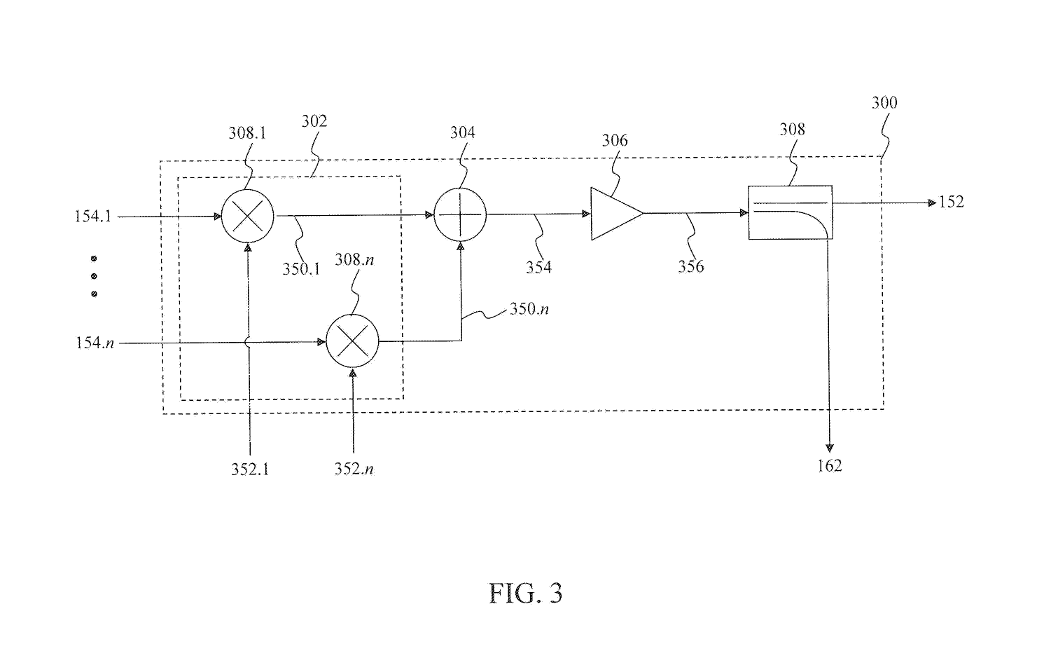

FIG. 3 illustrates exemplary analog transmission circuitry that can be implemented within the transmitter of the transceiver according to an exemplary embodiment of the present disclosure. Analog transmission circuitry 300 amplifies, filters, frequency translates, and/or combines the compensated sequences of bits 154.1 through 154.n to provide the transmitted communication signal 152. In an exemplary embodiment, the analog transmission circuitry 300 can be implemented using as zero-intermediate frequency (IF) transmitter. The analog transmission circuitry 300 includes analog frequency translation circuitry 302, analog combination circuitry 304, an analog amplifier 306, and an analog coupler 308. The analog transmission circuitry 300 can represent an exemplary embodiment of the analog transmission circuitry 108.

The analog frequency translation circuitry 302 frequency translates the compensated sequences of bits 154.1 through 154.n to provide frequency translated sequences of bits 350.1 through 350.n. The analog frequency translation circuitry 302 includes mixers 308.1 through 308.n. Each of the mixers 308.1 through 308.n frequency translates a corresponding compensated sequence of bits from among the compensated sequences of bits 154.1 through 154.n in accordance with a corresponding local oscillator signal from among local oscillator signals 352.1 through 352.n.

Ideally, the local oscillator signals 352.1 through 352.n are of substantially similar frequencies but offset in phase from each other. However, in practice, the frequencies of the local oscillator signals 352.1 through 352.n can differ and the phase offsets between the local oscillator signals 352.1 through 352.n local oscillator signals 352.1 through 352.n may not be uniform. In this situation, these differences can cause mismatches in magnitude and/or phase between the frequency translated sequences of bits 350.1 through 350.n. These mismatches can introduce unwanted distortion into the frequency translated sequences of bits 350.1 through 350.n. In some situations, the unwanted distortion can be sufficiently severe to prohibit the compensated sequences of hits 154.1 through 154.n from being recovered from the transmitted communication signal 152. Furthermore, leakage of the local oscillator signals 352.1 through 352.n onto the frequency translated sequences of bits 350.1 through 350.n can introduce unwanted interference onto the frequency translated sequences of bits 350.1 through 350.n. In some situations, the unwanted interference can be sufficiently severe to prohibit the compensated sequences of bits 154.1 through 154.n from being recovered from the transmitted communication signal 152.

The analog combination circuitry 304 combines the frequency translated sequences of bits 350.1 through 350.n to provide a combined communication signal 354.

The analog amplifier 306 amplifies the combined communication signal 354 to provide an amplified communication signal 356. The analog amplifier 306 can be implemented as a linear amplifier, also referred to as a power amplifier, whose output is proportional to its input. The linear amplifier can include a Class A amplifier or any other suitable linear amplifier that will be apparent to those skilled in the relevant art(s) without departing from the spirit and scope of the present disclosure. In some situations, the local oscillator signals 352.1 through 352.n can couple onto the transmitted communication signal 152 introducing unwanted interference onto the amplified communication signal 356. In these situations, the unwanted interference can be sufficiently severe to prohibit the compensated sequences of bits 154.1 through 154.n from being recovered from the transmitted communication signal 152.

The analog coupler 308 separates the amplified communication signal 356 into the transmitted communication signal 152 and the impairment measurement signal 162.

Although not illustrated in FIG. 3, those skilled in the relevant art(s) will recognize that the analog transmission circuitry 300 can include one or more other analog amplifiers and/or one or more analog filters without departing from the spirit and scope of the present disclosure. The one or more other analog amplifiers amplify various analog signals, such as the compensated sequences of bits 154.1 through 154.n to provide an example, within the analog transmission circuitry 300. The one or more analog filters decrease unwanted frequency components within various analog signals, such as the compensated sequences of bits 154.1 through 154.n to provide an example, within the analog transmission circuitry 300.

### Exemplary Analog Receiving Circuitry that can be Implemented within a Receiver of the Transceiver

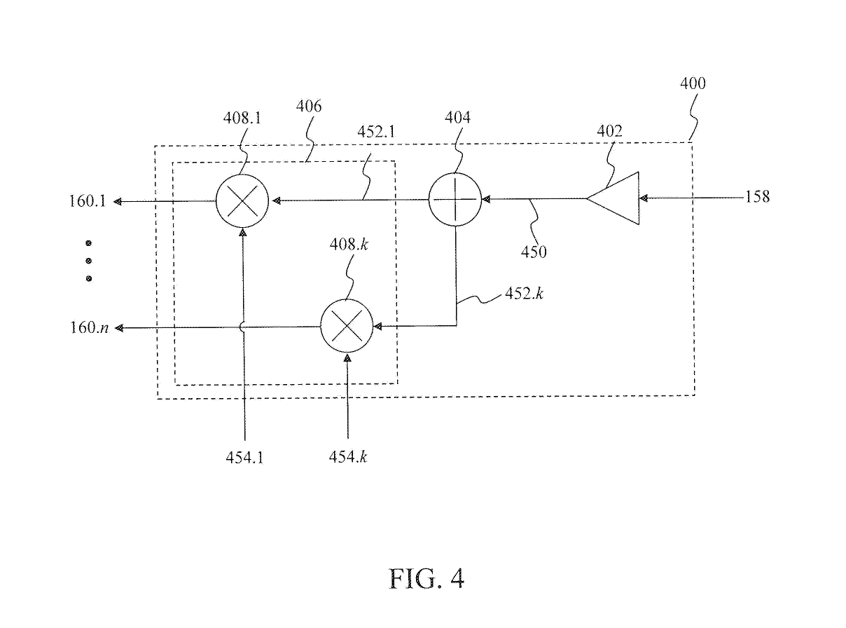

FIG. 4 illustrates exemplary analog receiving circuitry that can be implemented within a receiver of the transceiver according to an exemplary embodiment of the present disclosure. Analog receiving circuitry 400 amplifies, filters, frequency translates, and/or separates the received communication signal 158 to provide the recovered sequences of bits 160.1 through 160.k. In an exemplary embodiment, the analog receiving circuitry 400 can be implemented using as zero-intermediate frequency (IF) receiver. The analog receiving circuitry 400 includes an analog amplifier 402, analog separation circuitry 404, and analog frequency translation circuitry 406. The analog transmission circuitry 300 can represent an exemplary embodiment of the analog receiving circuitry 110.

The analog amplifier 402 amplifies the received communication signal 158 to provide an amplified received communication signal 450. The analog amplifier 402 can be implemented as a low-noise amplifier (LNA).

The analog separation circuitry 404 separates the amplified received communication signal 450 to provide recovered communication signals 452.1 through 452.k.

The analog frequency translation circuitry 406 frequency translates the recovered communication signals 452.1 through 452.k to provide the recovered sequences of bits 160.1 through 160.k. The analog frequency translation circuitry 406 includes mixers 408.1 through 408.k. Each of the mixers 408.1 through 408.k frequency translates a corresponding recovered communication signal from among the recovered communication signals 452.1 through 452.k in accordance with a corresponding local oscillator signal from among local oscillator signals 454.1 through 454.k.

Although not illustrated in FIG. 4, those skilled in the relevant art(s) will recognize that the analog receiving circuitry 400 can include one or more other analog amplifiers and/or one or more analog filters without departing from the spirit and scope of the present disclosure. The one or more other analog amplifiers amplify various analog signals, such as the recovered sequences of bits 160.1 through 160.k to provide an example, within the analog receiving circuitry 400. The one or more analog filters decrease unwanted frequency components within various analog signals, such as the recovered sequences of bits 160.1 through 160.k to provide an example, within the analog receiving circuitry 400.

### CONCLUSION

The following Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment can not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The exemplary embodiments described within the disclosure have been provided for illustrative purposes, and are not intend to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based on the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

1. A transceiver, comprising:
a transmitter configured to operate on a plurality of sequences of bits to provide a transmitted communication signal; and
a receiver, including an envelope detector, configured to operate upon a received communication signal to provide a plurality of recovered sequences of bits,
wherein the envelope detector is configured to measure an envelope of the transmitted communication signal, and
wherein the transmitter is further configured to adjust a magnitude or a phase of the plurality of sequences of bits according to a set of filter coefficients generated based on the envelope of the transmitted communication signal.

2. The transceiver of claim 1, wherein the transmitter comprises:
digital compensation circuitry configured to:
generate the set of filter coefficients in a digital signal domain based on the envelope of the transmitted communication signal at a first rate,
map the plurality of sequences of bits onto a symbol constellation in accordance with a digital modulation scheme at a second rate,
interpolate the mapped sequence of bits from the second rate to the first rate,
adjust the magnitude or the phase of the interpolated mapped sequence of bits in the digital signal domain in accordance with the set of filter coefficients at the first rate to generate an adjusted sequence of bits, and
provide a second plurality of sequences of bits based on the adjusted sequence of bits, the second plurality of sequences of bits being offset in phase from each other; and
analog transmission circuitry configured to:
frequency translate the second plurality of sequences of bits in accordance with a plurality of local oscillator signals, and
combine the frequency translated second plurality of sequences of bits to provide the transmitted communication signal.

3. The transceiver of claim 2, wherein the digital compensation circuitry comprises:
a digital coefficient generation module configured to:
compare a digital representation of the envelope of the transmitted communication signal with the interpolated mapped sequence of bits to generate an error signal, and
generate the set of filter coefficients based on the error signal using an adaptive filtering algorithm; and
an adaptive filter module configured to adjust its impulse response in accordance with the set of filter coefficients to adjust the magnitude or the phase of the mapped sequence of bits.

4. The transceiver of claim 3, wherein the adaptive filtering algorithm comprises:
a Least Mean Squared (LMS) algorithm;
a Recursive Least Squares (RLS) algorithm; or
a Minimum Mean Squared Error (MMSE) algorithm.

5. The transceiver of claim 2, wherein the analog transmission circuitry comprises:
a plurality of mixers, each mixer from among the plurality of mixers being configured to frequency translate a corresponding sequence of bits from among the second, plurality of sequences of bits in accordance with a corresponding local oscillator signal from among the plurality of local oscillator signals;
analog combination circuitry configured to combine the frequency translated second plurality of sequences of bits to provide a combined communication signal;
an analog amplifier configured to amplify the combined communication signal to provide an amplified communication signal; and
an analog coupler configured to separate the amplified communication signal into the transmitted communication signal and an impairment measurement signal,
wherein the envelope detector is configured to measure the envelope of the transmitted communication signal based on the impairment measurement signal.

6. The transceiver of claim 1, wherein the transmitted communication signal is substantially similar to an impairment measurement signal except for a difference in phase or magnitude.

7. The transceiver of claim 1, wherein analog receiving circuitry comprises:
an analog amplifier configured to amplify the received communication signal to provide an amplified received communication signal;
analog separation circuitry configured to separate the amplified received communication signal to provide a plurality of recovered communication signals; and
a plurality of mixers, each mixer from among the plurality of mixers being configured to frequency translate a corresponding recovered communication signal from among the plurality of recovered communication signals in accordance with a corresponding local oscillator signal from among the plurality of local oscillator signals to provide the plurality of recovered sequences of bits.

8. A transceiver, comprising:
a transmitter, formed on a substrate, configured to operate on a plurality of sequences of bits to provide a first communication signal and to separate the first communication signal into a second communication signal and a third communication signal, the second communication signal being substantially similar to the third communication signal except for a difference in phase or magnitude; and
a receiver, including an envelope detector formed on the substrate, configured to receive the third communication signal, the envelope detector being configured to measure an envelope of the third communication signal, and
wherein the transmitter is further configured to adjust a magnitude or a phase of the plurality of sequences of bits based on a set of filter coefficients generated based on the envelope of the third communication signal.

9. The transceiver of claim 8, wherein the transmitter comprises:
digital compensation circuitry configured to:
generate the set of filter coefficients in a digital signal domain based on the envelope of the third communication signal at a first rate,
map the plurality of sequences of bits onto a symbol constellation in accordance with a digital modulation scheme at a second rate, interpolate the mapped sequence of bits from the second rate to the first rate,
adjust the magnitude or the phase of the interpolated mapped sequence of bits in the digital signal domain in accordance with the set of filter coefficients at the first rate to provide an adjusted sequence of bits, and
provide a second plurality of sequences of bits based on the adjusted sequence of bits, the second plurality of sequences of bits being offset in phase from each other; and
analog transmission circuitry configured to:
frequency translate the second plurality of sequences of bits in. accordance with a plurality of local oscillator signals, and
combine the frequency translated second plurality of sequences of bits to provide the second communication signal.

10. The transceiver of claim 9, wherein the digital compensation circuitry comprises:
a digital coefficient generation module configured to:
compare a digital representation of the envelope of the third communication signal with the interpolated mapped sequence of bits to generate an error signal, and
generate the set of filter coefficients based on the error signal using an adaptive filtering algorithm; and
an adaptive filter module configured to adjust its impulse response in accordance with the set of filter coefficients to adjust the magnitude or the phase of the mapped sequence of bits.

11. The transceiver of claim 10, wherein the adaptive filtering algorithm comprises:
a Least Mean Squared (LMS) algorithm;
a Recursive Least Squares (RLS) algorithm; or
a Minimum Mean Squared Error (MMSE) algorithm.

12. The transceiver of claim 9, wherein the analog transmission circuitry comprises:
a plurality of mixers, each mixer from among the plurality of mixers being configured to frequency translate a corresponding sequence of bits from among the second plurality of sequences of bits in accordance with a corresponding local oscillator signal from among the plurality of local oscillator signals;
analog combination circuitry configured to combine the frequency translated second plurality of sequences of bits to provide a combined communication signal;
an analog amplifier configured to amplify the combined communication signal to provide an amplified communication signal; and
an analog coupler configured to separate the amplified communication signal into the second communication signal and the third communication signal.

13. The transceiver of claim 8, wherein analog receiving circuitry comprises:
an analog amplifier configured to amplify a received communication signal to provide an amplified received communication signal;
analog separation circuitry configured to separate the amplified received communication signal to provide a plurality of recovered communication signals; and
a plurality of mixers, each mixer from among the plurality of mixers being configured to frequency translate a corresponding recovered communication signal from among the plurality of recovered communication signals in accordance with a corresponding local oscillator signal from among the plurality of local oscillator signals to provide a plurality of recovered sequences of bits.

14. A transceiver, comprising:
a transmitter, formed on a first substrate, configured to operate on a plurality of sequences of bits to provide a first communication signal and to separate the first communication signal into a second communication signal and a third communication signal;
a receiver, including an envelope detector formed on a second substrate, configured to receive the third communication signal, the envelope detector being configured to measure an envelope of the third communication signal; and
a mechanical enclosure configured to enclose the first substrate and the second substrate,
wherein the transmitter is further configured to adjust a magnitude or a phase of the plurality of sequences of bits based on a set of filter coefficients generated based on the envelope of the third communication signal.

15. The transceiver of claim 14, wherein the transmitter comprises:
digital compensation circuitry configured to:
generate the set of filter coefficients in a digital signal domain based on the envelope of the third communication signal,
map the plurality of sequences of bits onto a symbol constellation in accordance with a digital modulation scheme,
adjust the magnitude or the phase of the mapped sequence of bits in the digital signal domain in accordance with the set of filter coefficients, and
provide a second plurality of sequences of bits based on the adjusted sequence of bits, the second plurality of sequences of bits being offset in phase from each other; and
analog transmission circuitry configured to:
frequency translate the second plurality of sequences of bits in accordance with a plurality of local oscillator signals, and
combine the frequency translated second plurality of sequences of bits to provide the second communication signal.

16. The transceiver of claim 15, wherein the digital compensation circuitry comprises:
a digital coefficient generation module configured to:
compare a digital representation of the envelope of the third communication signal with the mapped sequence of bits to generate an error signal, and
generate the set of filter coefficients based on the error signal using an adaptive filtering algorithm; and
an adaptive filter module configured to adjust its impulse response in accordance with the set of filter coefficients to adjust the magnitude or the phase of the mapped sequence of bits.

17. The transceiver of claim 16, wherein the adaptive filtering algorithm comprises:
a Least Mean Squared (LMS) algorithm;
a Recursive Least Squares (RLS) algorithm; or
a Minimum Mean Squared Error (MMSE) algorithm.

18. The transceiver of claim 15, wherein the analog transmission circuitry comprises:
a plurality of mixers, each mixer from among the plurality of mixers being configured to frequency translate a corresponding sequence of bits from among the second plurality of sequences of bits in accordance with a corresponding local oscillator signal from among the plurality of local oscillator signals;
analog combination circuitry configured to combine the frequency translated second plurality of sequences of bits to provide a combined communication signal;
an analog amplifier configured to amplify the combined communication signal to provide an amplified communication signal; and
an analog coupler configured to separate the amplified communication signal into the second communication signal and the third communication signal.

19. The transceiver of claim 14, wherein the analog receiving circuitry comprises:
an analog amplifier configured to amplify a received communication signal to provide an amplified received communication signal;
analog separation circuitry configured to separate the amplified received communication signal to provide a plurality of recovered communication signals; and
a plurality of mixers, each mixer from among the plurality of mixers being configured to frequency translate a corresponding recovered communication signal from among the plurality of recovered communication signals in accordance with a corresponding local oscillator signal from among the plurality of local oscillator signals to provide a plurality of recovered sequences of bits.

20. The transceiver of claim 14, wherein the second communication signal is similar to the third communication signal except for a difference in phase or magnitude.
